(19) United States
(12) Patent Application Publication
(10) Pub. No.: US 2022/0314949 A1
(43) Pub. Date: Oct. 6, 2022

(54) VEHICULAR HYDRAULIC BRAKE SYSTEM

(71) Applicant: Ovik Leonardovich Mkrthyan, Moscow (RU)

(72) Inventors: Dmitry Vadimovich Medveded, Tashkent (UZ); Ovik Leonardovich Mkrthyan, Moscow (RU); Evgeniy Efimovich Mazo, Tashkent (UZ)

(73) Assignee: Ovik Leonardovich Mkrthyan, Moscow (RU)

(21) Appl. No.: 17/843,682

(22) Filed: Jun. 17, 2022

Related U.S. Application Data
(63) Continuation of application No. 16/345,714, filed on Apr. 28, 2019, now Pat. No. 11,364,889.

(30) Foreign Application Priority Data
Oct. 28, 2016 (UZ) FAP 20160125

(51) Int. Cl. B60T 13/58; B60T 7/04; B60T 13/14; B60T 13/74; F16D 65/16; F16D 65/28

(52) U.S. Cl. CPC B60T 13/58; B60T 7/04; B60T 13/145; B60T 13/741; F16D 65/16; F16D 65/28; B60T 2270/402; F16D 2121/04

(57) ABSTRACT

A transportation vehicle with a brake system designed for rapid deceleration of a moving vehicle, which enhances the effectiveness of vehicular braking in emergency situations, and increases the safety of automobile traffic on roads, which results in greater road-traffic safety due to enhanced reliability and higher effectiveness of braking under emergency situations.

A vehicular hydraulic brake system having a master brake cylinder with a hydraulic reservoir supplying a brake fluid, a control foot pedal and a vacuum booster connected to an operating brake cylinder of each wheel. The brake system has emergency braking assemblies mounted before the operating brake cylinders of at least rear wheels. The emergency braking assembly includes an electric mechanism operating in a reciprocating manner and has a rod attached to a piston of a hydraulic cylinder. An inlet hole of the hydraulic cylinder is connected to a pipeline in communication with the master braking cylinder. An outlet hole of the hydraulic cylinder is in communication with the operating brake cylinder. A top portion of the hydraulic cylinder has a compensation port in the close proximity to the electric mechanism, said compensation port being connected to the pipeline in communication with the master braking cylinder. A bottom portion of the hydraulic cylinder of the emergency braking assembly is disposed not lower than a top level of the operating brake cylinder.

### CROSS REFERENCE TO RELATED PATENT APPLICATIONS

The present invention is a continuation of U.S. patent application Ser. No. 16/345,714, filed Apr. 28, 2019, now U.S. Pat. No. 11,364,889 entitled “A VEHICULAR HYDRAULIC BRAKE SYSTEM,” which is a United States nationalization of PCT/UZ2017/000001, filed Jan. 31, 2017, and claims priority from Uzbekistanian Patent Application No. FAB 2016 0125, filed Oct. 28, 2016, entitled “A VEHICULAR HYDRAULIC BRAKE SYSTEM,” the subject matters of which are incorporated by reference herein in their entirety.

### TECHNICAL FIELD

The invention relates to transportation vehicle engineering and claimed hydraulic brake system is designed for rapid deceleration of a moving vehicle, enhancing an effectiveness of vehicular braking in emergency situations and increasing a safety of automobile traffic on roads.

### BACKGROUND OF THE INVENTION

The prior art generally illustrating a vehicular brake system having a pressure supply source in communication with brake cylinders of service braking, brake pads, emergency brake cylinders in communication with brake pads, wherein said emergency brake cylinders contain a substance with a high thermal expansion coefficient, and have electrical heaters connected to power source by means of control unit with a logic block.

In order to the control brake system conditions and modes of deceleration rate of vehicular wheels, the known brake systems have an indication block having at least four light-emitting diodes or LEDs connected to output leads of the logic block comprising at least four AND circuits, whose output leads are connected to a threshold element and an output lead of a switcher with at least 4 channels. Output leads of said 4-channel switcher are connected correspondingly to emergency brake elements with pressure sensors, while input leads of the 4-channel switcher are connected to a high-frequency generator, an amplifier and a thyristor, such as a power source described in U.S.S.R. Inventor's Certificate No. 1757937, B60T 13/74.

A drawback of the above-said known brake system of the prior art is insufficient reliability arising from a complex configuration of the system, which includes indication blocks and logic blocks, in addition to a need of using in emergency brake cylinders a substance with a high thermal expansion coefficient, and electrical heaters. Such system configurations lay a basis for risk of self-braking, especially when a vehicle is used in a hot climate.

The prior art also shows a vehicular hydraulic brake system having a master brake cylinder with a control pedal, wherein chambers of said master brake cylinder are in communication with two independent circuits of a drive used for driving operating brake cylinders for the front and rear wheels of the vehicle, and the brake system further having an electro-hydraulic signaling apparatus comprised of a housing encasing a piston for switching a signal circuit, each end chamber of the electro-hydraulic signaling apparatus being in communication with a corresponding independent circuit.

The operating brake cylinders of the known hydraulic brake system have emergency switch blocks used for switching the operating brake cylinder from a faulty brake circuit to an operative brake circuit, and are equipped with hydro-pyrotechnic means of emergency drive of operating brake cylinders, should both circuits become inoperable. Each emergency switch block is configured as a hydraulic cylinder having floating pistons, channels communicating end chambers of the hydraulic cylinder and a chamber between the floating pistons with the operating brake cylinder, channels for connecting the end chambers of the hydraulic cylinder to brake circuits closed by a valve mounted on one of the floating pistons, and an electromagnetically driven closing valve electrically connected to corresponding leads of the electro-hydraulic signaling apparatus.

The hydro-pyrotechnic means of emergency drive of operating brake cylinders is configured as a hydraulic cylinder having pyrotechnic cartridges, whose igniting fuse is connected to the switch circuit controlled by brake pedal at a maximal pedal stroke, while a chamber of said hydraulic cylinder is communicated via a non-return valve with a chamber defined between the floating pistons of emergency switch blocks (U.S.S.R. Inventor's Certificate No. 1202930, B60T11/32).

The drawback of the above-said vehicular hydraulic brake system known from the prior art is a complex configuration of the brake system which includes, apart from a master brake cylinder, emergency switch blocks used for switching the operating brake cylinder from a faulty brake circuit to an operative brake circuit, and equipped with hydro-pyrotechnic means of emergency drive of operating brake cylinders, should both circuits become inoperable. In addition, each emergency switch block is configured as a hydraulic cylinder having floating pistons, an electromagnetically driven closing valve, wherein the electromagnetic valve drive is electrically connected to the electro-hydraulic signaling apparatus.

The known hydraulic brake system also includes the aforesaid hydro-pyrotechnic means, which contributes to the complexity of system configuration and adds problems relating to system maintenance, as there is a need for the reloading of pyrotechnic cartridges used. Besides, in the event of a failure of the main or reserve hydraulic pressure drive for any reason (e.g., due to pipeline damage or disintegration), the brake system may become inoperable as a result of insufficiently reliable system configuration.

Technically, a brake system known from the prior art, which is particularly relevant, is a hydraulically-driven brake system (as disclosed in Legkovye Avtomobily Journal, 5^{th} edition revised and extended, ref. “The Manual on Training B Category Vehicle Drivers” by K. S. Shestopalov, Moscow, published by DOSAAF organization, U.S.S.R., 1984, p.p. 149-151). The analogous vehicular hydraulic brake system known from the prior art includes a pedal of an operating brake system, a master brake cylinder, a hydraulic reservoir supplying a brake fluid, a vacuum booster and a pressure regulator present in the hydraulic circuit of rear wheels of the vehicle, pipelines and flexible lines, levers of parking brake system drive, an equalizer, cables, brake pad release levers, braking mechanisms of rear wheels. A hydraulic drive of the operating brake system is arranged to produce a separate action, i.e., such hydraulic drive activated by a common foot pedal acts separately on respective braking mechanisms of the front wheels and the rear wheels of the vehicle.

Providing of separate hydraulic drives ensures vehicle deceleration if a sealing loss occurs in one circuit of hydraulic fluid pipeline (serving either front wheels or rear wheels of the vehicle).

In this known brake system, a foot pedal of service brake is coupled to a pusher disclosed in a piston chamber of a master brake cylinder having a casing with a brake fluid supply reservoir mounted above said casing and arranged in fluid communication with the brake cylinder chamber. Due to a pipeline, said master brake cylinder is in fluid communication with an operating brake cylinder of each wheel of the vehicle. The operating brake cylinder includes pistons arranged capable of interacting with brake pads coupled to each other by a coupling spring. The brake pads are positioned capable of interacting with a brake drum. In order to increase pressure, the system has a vacuum booster and a pressure regulator useful for regulating pressure in hydraulic drive of the rear wheels of the vehicle.

A strong disadvantage of the known hydraulic brake system described above is lesser road-traffic safety since a vehicle may be incapable to stop in emergency situation as said vehicular hydraulic brake system may become inoperable, for example because of a failure which might occur in the master brake cylinder, or in case of brake fluid leakage due to a loss of sealing or physical disintegration or damage of the hydraulic system, or in the event of a damage of the pipes constituting both circuits of the hydraulic drive of the brake system. If this occurs, a driver is unable to stop a moving vehicle and an emergency situation may happen on the road as a result of the foregoing.

### OBJECTIVES OF THE INVENTION

An objective of the claimed invention is to enhance road-traffic safety by means of increasing both reliability and effectiveness of decelerating a vehicle in emergency situations.

### SUMMARY OF THE INVENTION

The defined objective is gained by providing a vehicular hydraulic brake system comprising a master brake cylinder with a hydraulic reservoir supplying a brake fluid, a control foot pedal and a vacuum booster connected by means of main pipelines to an operating brake cylinder of each wheel, the system further has emergency braking assemblies mounted before the operating brake cylinders of at least rear wheels, said emergency braking assembly comprising an electric mechanism operating in a reciprocating manner and having a rod, said rod is attached to a piston of a hydraulic cylinder having a top portion with an inlet hole and an outlet hole, said inlet hole being connected to the main pipeline and said outlet hole being in communication with the operating brake cylinder, wherein the top portion of the hydraulic cylinder has a compensation port in the close proximity to the electrical mechanism, said compensation port receiving an additional pipeline in communication with the main pipeline.

The defined objective of invention is also gained by that a bottom portion of a casing of the hydraulic cylinder of the emergency braking assembly is disposed not lower than an upper level of the operating braking cylinder.

Providing the hydraulic brake system with emergency braking assemblies activated by pressing a control button of the vehicle dashboard for emergency braking, regardless of operability of the master brake cylinder, integrity and leak-proofness of the entire brake system, enables a vehicle driver to effect emergency deceleration of a vehicle in case of both the presence of the brake fluid in the system and lack of it as a result of leakage, or in case of pipeline disintegration or damage. This contributes a lot to vehicle reliability and road traffic safety.

The emergency braking assembly can be mounted both before operating brake cylinders of rear wheels and before operating brake cylinders of all wheels, thus increasing further both reliability and effectiveness of decelerating the vehicle in emergency.

Making inlet and outlet holes in the hydraulic cylinder allows to attach said emergency braking assembly to the pipeline communicating the master brake cylinder with the operating brake cylinders and to brake system of any type, regardless of differences in mechanical parts.

Attachment of the hydraulic cylinder piston to the electric mechanism rod in order to produce brake fluid pressure in the operating brake cylinders in any case enables to enhance reliability and effectiveness of emergency braking.

Providing a compensation port connected to a pipeline in communication with a master brake cylinder enables to avoid a negative pressure in the rod end region of the hydraulic cylinder during its motion. This leads to more reliable operation of emergency braking assembly and the entire brake system.

Making both inlet hole and compensation port in the top portion of the casing of the hydraulic cylinder allows to avoid brake fluid losses, thus making the entire brake system more reliable.

Disposition of the bottom portion of the casing of the hydraulic cylinder not lower than the top level of the operating brake cylinder also enables one to avoid brake fluid losses in case of pipeline disintegration, thus contributing more to the reliability of the entire brake system.

### BRIEF DESCRIPTION OF THE DRAWING

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 is a representative schematic view of various operating principles of the claimed brake system according to a first embodiment configuration;

FIG. 2 is a representative schematic view of operating principles of the claimed brake system when the emergency braking assembly is in an idle configuration;

FIG. 3 is a representative schematic view of operating principles of the claimed brake system of an emergency braking assembly under an emergency situation (for example, when there is a failure of a master brake cylinder); and

FIG. 4 is a representative schematic view of operating principles of the claimed brake system of an emergency braking assembly in operational condition in case of damage of hydraulic drive pipes and a full loss of brake fluid in the system.

### DETAILED DESCRIPTION OF THE PRESENT INVENTION

The present invention will now be described more fully hereinafter with reference to the accompanying DRAWINGS, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

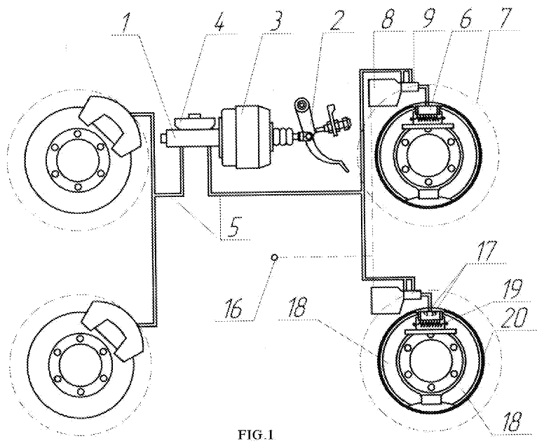

With reference to the DRAWINGS, particularly FIG. 1, a vehicular hydraulic brake system is comprised of a master brake cylinder 1 connected to a spring-assisted footbrake pedal 2 through a vacuum booster 3, wherein a hydraulic reservoir 4 supplying the brake fluid is mounted on said master brake cylinder. The master brake cylinder 1 is configured to be in fluid communication via a pipeline 5 with operating brake cylinder 6 of each wheel 7.

Ahead of said operating brake cylinder 6 of each wheel 7, there is an emergency braking assembly comprising an electrical mechanism 8 designed to operate in a reciprocating manner and a hydraulic cylinder 9. For better effectiveness of braking, said emergency braking assembly can be mounted before said operating brake cylinder 6 of each of the four wheels 7.

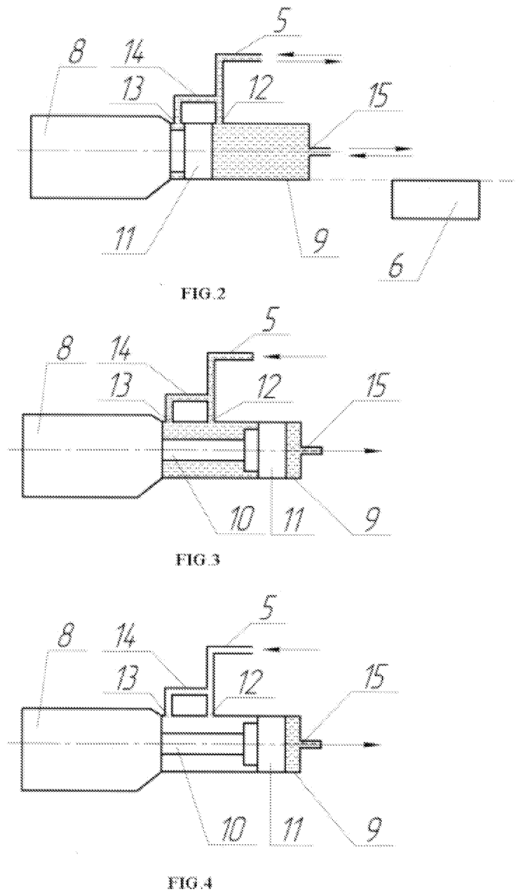

The hydraulic cylinder 9 is in communication with said electric mechanism 8 in a hermetically sealed manner A rod 10 of electrical mechanism 8, shown in FIG. 3, is attached to a piston 11 of hydraulic cylinder 9, as shown in FIGS. 2 and 3. A top portion of a casing of said hydraulic cylinder 9 has an inlet hole 12 which receives pipeline 5 communicating with master brake cylinder 2, as shown in FIG. 1. The top portion of said casing of the hydraulic cylinder 9 also has a compensation port 13 in communication via an additional pipeline 14 with above-said pipeline 5. The compensation port 13 is made in the casing of the hydraulic cylinder 9 in the close proximity to electrical mechanism 8. An end of hydraulic cylinder 9 has an outlet hole 15 which receives the operating hydraulic cylinder 6 of each rear wheel 7.

As shown in FIG. 2, a bottom portion of the casing of hydraulic cylinder 9 of said emergency braking assembly is disposed not lower than an upper level of the aforesaid operating cylinder 6.

It should be understood that a dashboard of the vehicle has a press button 16 to control the emergency braking assembly, as generally indicated in FIG. 1.

With reference to FIG. 1, the operating brake cylinder 6 of each wheel 7 comprises pistons 17 mounted and capable of interacting with brake pads 18 coupled with each other by a coupling spring 19. The brake pads 18 so positioned are capable of interacting with a brake drum 20 of each wheel 7.

Pipelines 5, chambers of master brake cylinder 1, hydraulic cylinder 9 and all operating cylinders 6 contain a brake fluid coming from a hydraulic reservoir 4 to supply the brake fluid.

A vehicular hydraulic brake system operates in the following manner.

During braking, when a driver puts a pressure upon a pedal 2 via a master cylinder 1, said brake fluid is displaced to pipelines 5 and an operating cylinder 6 of each wheel 7, as illustrated in FIG. 1. The operating brake cylinder 6 of each rear wheel 7 receives the brake fluid coming through the aforementioned holes 12 and 15 of the hydraulic cylinder 9, as shown, for example, in FIG. 2. Under idle conditions, a piston 11 within hydraulic cylinder 9 is disposed in the close proximity to electric mechanism 8. A chamber of the hydraulic cylinder 9 contains the brake fluid filling a rod end region which flows along the aforesaid additional pipeline 14.

Being contained within the operating brake cylinder 6 of each wheel, the brake fluid causes the pistons 17 to move and, as a result of such motion, brake pads 18 are forced against the brake drum 20. When a gap between the brake pads 18 and the brake drums 20 disappears, a displacement of brake fluid from the master brake cylinder 1 to the operating brake cylinder 6 becomes impossible. Further increases in pressing force applied to pedal 3 results in greater pressure of the brake fluid in the brake system, activating thereby a simultaneous braking of all wheels 7.

The greater a force is applied to pedal 3, the more pressure is then produced by the master brake cylinder 1 to act upon the fluid, and this greater force acts through pistons 17 of each operating brake cylinder 6 upon the respective brake pads 18.

When the pressure upon the pedal 3 is interrupted, all said members return to their original positions, and the compressed coupling springs 19 retract the brake pads 18 from the brake drums 20. The pistons 17 of operating brake cylinders 6 approach each other to displace the brake fluid from each brake cylinder 6 to the master brake cylinder 1.

In emergency situations, for example, when the main brakes of the vehicle fail as a result of a breakdown of master brake cylinder 1, as shown in FIG. 3, or in the case of brake fluid leakage because of the aforementioned hydraulic brake system becomes unsealed or as a result of a damage to a pipeline 5, as shown in FIG. 4, there is thus no pressure in the brake cylinders 6 and no braking can be done. In this particular case, a driver activates the aforedescribed electric mechanism 8 by pressing a control button 16. A rod 10 of said electric mechanism 8 then sets a piston 11 of a hydraulic cylinder 9 in motion. While, during such motion, said piston 11 of the hydraulic cylinder 9 covers inlet hole 12, the above-said brake fluid (or air) coming from pipeline 5 through the additional pipeline 14 via the compensation port 13 arrives to a rod end of the hydraulic cylinder 9, preventing thereby the vacuum production in a chamber of the hydraulic cylinder 9 between the electric mechanism 8 and piston 11. The brake fluid remaining in hydraulic cylinder 9 comes under the pressure of piston 11 through an outlet hole 15 into the operating brake cylinder 6.

Being contained within the operating brake cylinder 6 of each wheel 7, the brake fluid causes the pistons 17 to move and, as a result of such motion, the brake pads 18 are forced against the brake drum 20, and emergency braking occurs for this particular reason.

The suggested vehicular hydraulic brake system set forth herein is useful for mounting on automobiles either equipped with ABS systems or free of such ABS systems. The suggested system is also fully fit to replace electrically-driven stopping (parking) brake or hand brake.

The suggested vehicular hydraulic brake system is applicable to any vehicles equipped with a hydraulic braking system, no matter which type of brakes (disk or drum type brakes) is available on a vehicle. In addition, the claimed brake system enables the installation of emergency brake assemblies on those vehicles currently in operation, while stationed in auto repair shop, without having to add any modifications to automobile design. The suggested structure of the brake system is capable of decelerating a vehicle in any emergency situation caused by a malfunction of the main brakes, including a loss of brake fluid in hydraulic circuit, and it also enables to avoid emergency situations on roads, thus contributing a lot to road-traffic safety.

The previous descriptions are of preferred embodiments for implementing the invention, and the scope of the invention should not necessarily be limited by these descriptions. It should be understood that all articles, references and citations recited herein are expressly incorporated by reference in their entirety. The scope of the current invention is defined by the following claims.

What is claimed is:

1. A method for emergency wheel braking comprising:
activating an emergency wheel braking device by pushing an activation button;
upon said activating, moving, by an electrical mechanism at one end of a hydraulic cylinder, a rod and piston connected thereto within said hydraulic cylinder from one end to the other end thereof,
whereby a wheel is braked.

2. The method for emergency wheel braking according to claim 1, wherein said step of moving further comprises:
wherein said rod is attached at one end to said electrical mechanism and at the other end to said piston,
wherein said hydraulic cylinder has a top portion thereof adjacent said electrical mechanism with an inlet hole therethrough, said inlet hole being adjacent said electrical mechanism and being connected to a main pipeline, and
wherein said hydraulic cylinder has an outlet hole, said outlet hole being disposed at the other end of said hydraulic cylinder and being in communication with an operating brake cylinder for a wheel,
wherein the top portion of said hydraulic cylinder has a compensation port therethrough, said compensation port disposed between the electrical mechanism and the input port, said compensation port in communication with the main pipeline,
whereby, when said emergency wheel braking device is activated in an emergency circumstance, said emergency assembly wheel braking device stops said wheel by the electrical mechanism driving the rod outwards along with the piston, said piston closing off said inlet hole from the operating brake cylinder, thereby allowing braking using the remaining brake fluid within the operating brake cylinder.

3. The method for emergency wheel braking according to claim 2, wherein:
disposing a bottom portion of a casing of said hydraulic cylinder not lower than an upper level of the operating braking cylinder.

4. The method for emergency wheel braking according to claim 2, further comprising:
connecting a pipeline to said compensation port and to a second pipeline connecting to said input port.

5. The method for emergency wheel braking according to claim 2, wherein said wheel comprises at least one rear wheel of a vehicle, and
further comprising:
mounting said emergency braking assembly before the operating brake cylinders of said at least one rear wheel.

6. The method for emergency wheel braking according to claim 5, wherein said wheel comprises at least one front wheel of a vehicle, and
further comprising:
mounting said emergency braking assembly before the operating brake cylinders of said at least one front wheel.
